(19) United States
(12) Patent Application Publication
(10) Pub. No.: US 2014/0271377 A1
(43) Pub. Date: Sep. 18, 2014

(54) MAGNET OPTIMIZATION DESIGN FOR SONIC REACTORS

(71) Applicant: PetroSonic Energy Inc., Calgary (CA)

(72) Inventors: Art AGOLLI, Calgary (CA); Patrick Brunelle, Langdon (CA); Alfred Fischer, Calgary (CA)

(73) Assignee: PetroSonic Energy Inc., Calgary (CA)

(21) Appl. No.: 14/209,188

(22) Filed: Mar. 13, 2014

Related U.S. Application Data
(60) Provisional application No. 61/792,557, filed on Mar. 15, 2013.

(51) Int. Cl. B01J 19/10

(52) U.S. Cl. CPC B01J 19/10
USPC 422/127

(57) ABSTRACT

Disclosed here are methods of determining magnet position and distance from a resonating component in a sonic reactor of use in upgrading Heavy Oil Feedstock's (HOFs).

### CROSS-REFERENCE TO RELATED APPLICATIONS

This application claims priority under 35 U.S.C. §119 to U.S. Provisional Patent Application Ser. No. 61/792,557, entitled “Magnet Optimization Design for Sonic Reactors,” filed Mar. 15, 2013, the entire contents of which are hereby incorporated herein by reference.

### BACKGROUND

1. Technical Field

This disclosure relates generally to sonic reactors and more particularly to the design and position of magnet drives in order to excite vibrations in a sonic reactor.

2. Background Information

Solvent deasphalting is a known solution for upgrading heavy crude oils into synthetic crude oils (SCOs), where the SCOs show an improved API gravity and a removal of one or more generally undesired elements in the oil, including asphaltenes, nickel, vanadium, and sulfur, amongst others. Some methods for performing this type of deasphalting use vibrational energy to aid in the process, typically using one or more vibrating bars. However, the use of vibrational energy or this purpose is somewhat recent, and the operational and design parameters of one or more aspects of these devices remain unknown in the art.

### SUMMARY

Disclosed here are methods of determining optimization of a magnet configuration in a sonic reactor of use in upgrading Heavy Oil Feedstock's (HOFs).

Relationships between the magnet position and their distance to the resonant bar are disclosed, as well as their influence in the vibrational characteristics in a sonic reactor and how this may affect operation when using said reactor to upgrade HOFs.

In one embodiment, a sonic reactor comprises: a resonating component having a first end and a second end; a first magnet drive and a second magnet drive respectively positioned at the first end of the resonating component and the second end of the resonating component, the first and second magnet drives are configured to excite the resonating component to a resonate frequency, wherein the first magnet drive includes a first set of electromagnets positioned around the first end of the resonating component and the second magnet drive includes a second set of electromagnets positioned around the second end of the resonating component; and a controller connected to the first and second magnet drives configured to activate the electromagnets in the first and second set of electromagnets so that the resonating component vibrates at the resonate frequency.

In another embodiment, a sonic reactor comprises: a resonating component having a first end and a second end; a first set of electromagnets positioned around the first end of the resonating and a second set of electromagnets positioned around the second end of the resonating component configured to excite the resonating component to a resonate frequency, wherein a center-point of a first electromagnet in the first set of electromagnets is positioned at 0 degrees around the resonating component, a center-point of a second electromagnet in the first set of electromagnets is positioned at 120 degrees around the resonating component, and a center-point of a third electromagnet in the first set of electromagnets is positioned at 240 degrees around the resonating component; and a controller connected to the first and second set of electromagnets configured to activate the electromagnets in the first and second set of electromagnets so that resonating component vibrates at the resonate frequency.

Numerous other aspects, features and advantages of the present disclosure may be made apparent from the following detailed description, taken together with the drawing figures.

Additional features and advantages of an embodiment will be set forth in the description which follows, and in part will be apparent from the description. The objectives and other advantages of the invention will be realized and attained by the structure particularly pointed out in the exemplary embodiments in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

The present disclosure can be better understood by referring to the following figures. The components in the figures are not necessarily to scale, emphasis instead being placed upon illustrating the principles of the invention. In the figures, any reference numerals designate corresponding parts throughout different views.

FIG. 1A depicts an isometric view of a sonicator used in upgrading heavy oil feedstock's, according to an embodiment of present disclosure.

FIG. 1B depicts a front view of a sonicator used in upgrading heavy oil feedstock, according to an embodiment of present disclosure.

FIG. 1C depicts a sectional view of a sonicator, according to an embodiment of present disclosure.

FIG. 1D depicts a second sectional view of a sonicator, according to an embodiment of present disclosure.

FIG. 2 depicts details of the magnet drives configuration.

### DETAILED DESCRIPTION

Disclosed here are design guidelines for sonic reactors of use in upgrading HOFs, according to an embodiment.

The present disclosure is here described in detail with reference to embodiments illustrated in the drawings, which form a part hereof. In the drawings, which are not necessarily to scale or to proportion, similar symbols typically identify similar components, unless context dictates otherwise. Other embodiments may be used and/or other changes may be made without departing from the spirit or scope of the present disclosure. The illustrative embodiments described in the detailed description are not meant to be limiting of the subject matter presented herein.

### DEFINITIONS

As used here, the following terms have the following definitions:

“Heavy Oil Feedstock (HOF)” may refer to materials that contain heavy oil with a specific gravity of less than 16 API.

“Upgrade” may refer to altering the chemical and/or physical properties of petroleum containing materials so as to increase the value of one or more of the resulting materials.

“Sonic Reactor” may refer to a device for upgrading HOFs by at least sonication.

“Reaction Chamber” may refer to a cavity in a sonic reactor where HOFs may be upgraded.

“Resonant Component” may refer to an element of a system which vibrates as part of the operation of a sonic reactor.

“Sonication” may refer to any device or system which produces vibrational energy sufficient to impact one or more desired end uses.

### DESCRIPTION OF THE DRAWINGS

Various example embodiments of the present disclosure are described more fully with reference to the accompanying drawings in which some example embodiments of the present disclosure are shown. Illustrative embodiments of the present disclosure are disclosed herein. However, specific structural and functional details disclosed herein are merely representative for purposes of describing example embodiments of the present disclosure. This disclosure however, may be embodied in many alternate forms and should not be construed as limited to only the embodiments set forth herein.

Reactor Operation

FIG. 1A shows 3D view 102, FIG. 1B shows front view 104, FIG. 1C shows right plane section 106, and FIG. 1D shows front plane section 108 of sonic reactor 100, according to an embodiment of the present disclosure. Sonic reactor 100 includes at least one resonating component 110, magnet drives 112, elastic support system 114, housing structure 116 and reaction chambers 118.

Resonating component 110 may have one or more natural frequencies and may be mounted on housing structure 116 using elastic support system 114. Elastic support system 114 may be placed between resonating component 110 and housing structure 116 and may be in physical contact with resonating component 110 at the node points; where there is substantially no vibration amplitude when resonating component 110 is vibrating at its natural frequency. This disposition of elastic support system 114 may minimize the loss of energy caused by the system. The magnet drives 112 may be positioned at the ends of resonating component 110. In one embodiment, magnet drives 112 may include series of electromagnets arranged around the ends of the resonating component 110 and may be connected to a controller and a power source. Magnet drives 112 may be capable of exciting resonating component 110 to at least one natural frequency and maintain the system in resonance for a desired time.

The vibration of resonating component 110 at its natural frequency may result in high amounts of energy being transferred to the reaction chambers 118, which may be mechanically coupled to resonating component 110. This energy may be used to accelerate chemical reactions. One example of such reactions is the deasphalting of HOF. According to an embodiment, HOF in reaction chambers 118 may have previously been chemically altered to allow the upgrading of HOF in reaction chamber 118, methods for preparing it for such including the addition of one or more solvents.

The period of time needed to upgrade HOF in reaction chambers 118 may vary in dependence with a number of factors, including the amplitude and frequency of the vibration of resonating component 110. The amplitude and frequency of the vibration of resonating component 110 may in turn depend on the interrelation of several characteristics of the system including the shape and mass of the resonating component 110, the mass and location of the reaction chambers 118, the design of the elastic support system 114, the properties and location of magnet drives 112 and the characteristics of the power supply amongst others.

The amplitude of the vibration depends on the excitation force and the damping characteristics of the system, the actual amplitude of sonic reactor 100 is a result of the equilibrium between the energy supplied to the system by the excitation force and the energy dissipated in the system. The energy dissipated by the system may be referred as damping. The damping in sonic reactor 100 may have two components, the internal damping and the external damping. The internal damping refers to the energy that may dissipate due to the resonating component 110 and may be affected by the material properties and the shape of resonating component 110. The external damping effects may be affected by the mass of reaction chambers 118, the friction between elements and other energy dissipating factors. Typically the external damping is an order of magnitude higher than the internal damping.

The mass of resonating component 110 may be redistributed to increase the energy transmission towards the resonance chambers and optimize the system for specific application requirements. The proper selection of the material may allow improved elasticity and lower internal damping, which may increase the amplitude at a given power and the tuning of the natural frequency. These factors may translate on higher energy transmission towards the resonance chambers.

Magnet Drive Position and Distance Relationship with Resonator Bar.

FIG. 2 is a magnet configuration 200 and their relationship to resonating component 110. Magnet drives 112 may be positioned at 120° with respect to the center of each other in order to cover the 360° area surrounding resonating component 110.

The distance between each magnet drive 112 and resonating component 110 depicted in portion “A” of FIG. 2 may also be proportional to the oscillation amplitude of resonating component 110. For example, if the desired amplitude for oscillation of resonating component 110 is 4 mm the distance between magnet drive 112 may be at least 4.1 mm in order to prevent a physical contact between resonating component 110 and magnet drive 112 when resonating at a 4 mm amplitude. A physical contact between resonating component 110 and magnet drive 112 may damage or prevent proper functioning of sonic reactor 100.

Another variable to determine the distance between magnet drives 112 and resonating component 110 may be the inverse-square law. If a higher amplitude is desired the distance between magnet drives 112 and resonating component 110 may be increased; however, magnet drive 112 may require additional power input in order to cover the additional distance and provide the same effect. The distance may be set to the minimal distance possible that may allow the desired amplitude (without engaging in physical contact of magnet drives 112 and resonating component 110) with the minimal use of power in magnet drive 112.

Each magnet drive 112 may be powered by a single phase input in order to produce a 3-phase power supply.

### EXAMPLES

In example #1, the desired amplitude of vibration may be 4 mm. One magnet drive 112 may be turned on pulling resonating component 110 4 mm towards the magnet, 4 msecs later a second magnet drive 112 may be turned on pulling resonating component 110 4 mm towards the magnet and the first magnet drive 112 may be turned off. 4 msecs later a third magnet drive 112 may be turned on pulling resonating component 110 4 mm towards the magnet and the second magnet drive 112 may be turned off. 4 msecs later the first magnet drive 112 may be turn on restarting the cycle. This may cause a three-phase vibration of resonating component 110 for each cycle. The process may continue for the period of time needed to upgrade HOF.

While various aspects and embodiments have been disclosed herein, other aspects and embodiments are contemplated. The various aspects and embodiments disclosed herein are for purposes of illustration and are not intended to be limiting, with the true scope and spirit being indicated by the following claims.

The embodiments described above are intended to be exemplary. One skilled in the art recognizes that numerous alternative components and embodiments that may be substituted for the particular examples described herein and still fall within the scope of the invention.

What is claimed is:

1. A sonic reactor comprising:
a resonating component having a first end and a second end;
a first magnet drive and a second magnet drive respectively positioned at the first end of the resonating component and the second end of the resonating component, the first and second magnet drives are configured to excite the resonating component to a resonate frequency, wherein the first magnet drive includes a first set of electromagnets positioned around the first end of the resonating component and the second magnet drive includes a second set of electromagnets positioned around the second end of the resonating component; and
a controller connected to the first and second magnet drives configured to activate the electromagnets in the first and second set of electromagnets so that the resonating component vibrates at the resonate frequency.

2. The sonic reactor of claim 1, wherein an amplitude and a frequency of the vibration of the resonating component depends on the shape and mass of the resonating component.

3. The sonic reactor of claim 1, further comprising:
a first and a second elastic support system respectively contacting the resonating component at the first end and the second end of the resonating component, wherein the first and second elastic support system is positioned between the resonating component and a housing system mounting the resonating component.

4. The sonic reactor of claim 3, wherein an amplitude and a frequency of the vibration of the resonating component depends on a design of the elastic support system.

5. The sonic reactor of claim 1, wherein a center-point of a first electromagnet in the first set of electromagnets is positioned at 0 degrees around the resonating component, a center-point of a second electromagnet in the first set of electromagnets is positioned at 120 degrees around the resonating component, and a center-point of a third electromagnet in the first set of electromagnets is positioned at 240 degrees around the resonating component.

6. The sonic reactor of claim 1, wherein a center-point of a first electromagnet in the second set of electromagnets is positioned at 0 degrees around the resonating component, a center-point of a second electromagnet in the second set of electromagnets is positioned at 120 degrees around the resonating component, and a center-point of a third electromagnet in the second set of electromagnets is positioned at 240 degrees around the resonating component.

7. The sonic reactor of claim 1, wherein the distance between each magnet in the first and second set of electromagnets and the resonating bar is proportional to a resonating amplitude of the resonating component.

8. The sonic reactor of claim 7, wherein the distance between each magnet in the first and second set of electromagnets and the resonating bar is set to the minimal distance possible to allow the resonating component to vibrate at the resonating amplitude without contacting the first and second set of electromagnets.

9. The sonic reactor of claim 1, wherein each electromagnet in the first set of electromagnets is powered by a single phase input of three phase power.

10. The sonic reactor of claim 1, wherein each electromagnet in the second set of electromagnets is powered by a single phase input of three phase power.

11. A sonic reactor comprising:
a resonating component having a first end and a second end;
a first set of electromagnets positioned around the first end of the resonating and a second set of electromagnets positioned around the second end of the resonating component configured to excite the resonating component to a resonate frequency, wherein a center-point of a first electromagnet in the first set of electromagnets is positioned at 0 degrees around the resonating component, a center-point of a second electromagnet in the first set of electromagnets is positioned at 120 degrees around the resonating component, and a center-point of a third electromagnet in the first set of electromagnets is positioned at 240 degrees around the resonating component; and
a controller connected to the first and second set of electromagnets configured to activate the electromagnets in the first and second set of electromagnets so that resonating component vibrates at the resonate frequency.

12. The sonic reactor of claim 11, wherein an amplitude and a frequency of the vibration of the resonating component depends on the shape and mass of the resonating component.

13. The sonic reactor of claim 11, further comprising:
a first and a second elastic support system respectively contacting the resonating component at the first end and the second end of the resonating component, wherein the first and second elastic support system is positioned between the resonating component and a housing system mounting the resonating component.

14. The sonic reactor of claim 13, wherein an amplitude and a frequency of the vibration of the resonating component depends on a design of the elastic support system.

15. The sonic reactor of claim 11, wherein a center-point of a first electromagnet in the second set of electromagnets is positioned at 0 degrees around the resonating component, a center-point of a second electromagnet in the second set of electromagnets is positioned at 120 degrees around the resonating component, and a center-point of a third electromagnet in the second set of electromagnets is positioned at 240 degrees around the resonating component.

16. The sonic reactor of claim 11, wherein the distance between each magnet in the first and second set of electromagnets and the resonating bar is proportional to a resonating amplitude of the resonating component.

17. The sonic reactor of claim 16, wherein the distance between each magnet in the first and second set of electromagnets and the resonating bar is set to the minimal distance possible to allow the resonating component to vibrate at the resonating amplitude without contacting the first and second set of electromagnets.

18. The sonic reactor of claim 11, wherein each electromagnet in the first set of electromagnets is powered by a single phase input of three phase power.

19. The sonic reactor of claim 11, wherein each electromagnet in the second set of electromagnets is powered by a single phase input of three phase power.
